(19) United States
(12) Patent Application Publication
(10) Pub. No.: US 2021/0304180 A1
(43) Pub. Date: Sep. 30, 2021

(54) Intelligent Wire Transfer Automation System

(71) Applicant: Qolo, Inc., Fort Lauderdale, FL (US)

(72) Inventors: Darren Beyer, Lafayette, CA (US); Steven Bishop, Fort Lauderdale, FL (US); Patricia Montesi, Fort Lauderdale, FL (US); Robert Pincus, Fort Lauderdale, FL (US)

(73) Assignee: QOLO, Inc., Fort Lauderdale, FL (US)

(21) Appl. No.: 17/213,072

(22) Filed: Mar. 25, 2021

Related U.S. Application Data
(60) Provisional application No. 63/000,204, filed on Mar. 26, 2020.

(51) Int. Cl. G06Q 20/22; G06Q 20/02; G06Q 20/10; G06Q 20/38

(52) U.S. Cl. CPC G06Q 20/227; G06Q 20/023; G06Q 20/381; G06Q 20/3827; G06Q 20/108

(57) ABSTRACT

A method of conducting payment against a specific invoice using a pseudo account and provisional accounts to improve the method of payments on a large-scale transaction system. Invoices may be delivered to a desired payer, and definitively marking that invoice as paid based on a matching of pseudo account and amount information. Some embodiments may include a payment system that delivers invoices, an account provisioning system that creates or selects accounts for assignment to specific invoices, an account monitoring system to continuously monitor destination bank accounts, and a payment reconciliation system for matching inbound payments to an invoice by utilizing bank account number and amount.

### PRIORITY

This application claims the benefit of co-pending U.S. provisional patent application 63/000,204 by the same inventors filed Mar. 26, 2020 which is incorporated by reference as if fully disclosed herein.

### BACKGROUND

Conventionally entities receiving funds to a bank account via wire transfers, automated clearinghouse (ACH) transfers, or other legacy bank transfers have limited means to reconcile incoming funds against mechanisms such as invoices used to request such funds. Limited mechanisms exist to reliably match a wire with a sender or sending entity. Such limitations impact the ability of straight-through-processing systems to utilize wires and ACH in an automated fashion.

### SUMMARY

Disclosed herein are improvements to systems and methods for facilitating transactions between a sending entity and a receiving entity who may have an established business relationship or may be transacting through a common entity such as a digital marketplace. These embodiments may include a smart account management system used to automate transaction reconciliation. Also disclosed is information on conducting payment transactions.

Some embodiments may include conducting payment against a specific invoice using a pseudo account and provisional accounts to improve the method of payments on a large-scale transaction system. In some embodiments the invoice information may be translated into ACH information to facilitate payment. Invoices may be delivered to a desired payer, and definitively marking that invoice as paid based on a matching of pseudo account and amount information. These embodiments may include one or more of a payment system that delivers invoices, an account provisioning system that creates or selects accounts or pseudo-accounts for assignment to specific invoices, an account monitoring system to continuously monitor destination bank accounts, and a payment reconciliation system for matching inbound payments to an invoice by utilizing bank account number and amount.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 describes some of the system components of the system and an overview of a process which may be effectuated in certain embodiments.

FIG. 2 describes some of the system components of the system and an overview of a process which may be effectuated in certain embodiments with multiple payors.

FIG. 3 describes some of the system components of the system and an overview of a process which may be effectuated in certain embodiments with multiple payees.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” and similar terms and phrases generally indicate any consequence, whether assured, probable, or merely possible, of a stated arrangement, cause, method, or technique, without any implication that an effect or a connection between cause and effect are intentional or purposive.

The term “Engine” and “Software Engine” generally refer to an element of software that encapsulated block of functionality. As used herein this may be any repeatable functionality, and includes, but is not limited to an application programming interface (API), a code library, software development kit (SDK) or software object.

The term “relatively” and similar terms and phrases generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” and similar terms and phrases generally indicates any case or circumstance in which a determination, measure, value, or otherwise, is equal, equivalent, nearly equal, nearly equivalent, or approximately, what the measure or value is recited. The terms “substantially all” and “substantially none” and similar terms and phrases generally indicate any case or circumstance in which all but a relatively minor amount or number for “substantially all” or none but a relatively minor amount or number for “substantially none” have the stated property. The terms “substantial effect” and similar terms and phrases generally indicate any case or circumstance in which an effect might be detected or determined.

The terms “this application”, “this description” and similar terms and phrases generally indicate any material shown or suggested by any portions of this application, individually or collectively, and include all reasonable conclusions that might be drawn by those skilled in the art when this application is reviewed, even if those conclusions would not have been apparent at the time this application is originally filed.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### Processing System

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output I/O devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover, any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant PDA, laptop, notebook and tablet computing devices operating through wireless networks. These wireless devices may include a processor, memory coupled to the processor, displays, keypads, WiFi, Bluetooth, GPS and other I/O functionality. Alternatively, the entire processing system may be self-contained on a single device or server.

### System Elements

Embodiments of the present invention relate to utilizing one or more of the following components to complete a transaction. There is however, no requirement that all of the system elements be used or that they be used in any particular combination. Moreover, many of the systems and sub-systems described herein may be effectuated using software engines.

A payment system which may send a request for payment or invoice which may also include payment account instructions.

A user interface to a payment system which a user may use to engage with the payment system.

An account provisioning system that may dynamically create or designate a destination bank account and may deliver payment account instructions to a system for ultimate delivery to a user.

A receiving bank account monitoring system which may periodically or in real-time deliver systemic notification that a payment has arrived.

A payment reconciliation system which may match a payment detected by an account monitoring system with a request for payment.

By using some or all of the system elements, a process for automating reconciliation of legacy bank funds transfers may be effectuated. In an exemplary embodiment a system may send an invoice for goods or services to a customer which may indicate such services, line item pricing, associated tax and total to be paid by the consumer. In some embodiments, foreign exchange fees may be present. Along with the invoice may be delivered a single-use or rotating provisioned receiving bank account information.

The consumer may access the invoice via a variety of physical or digital methods. The consumer may choose to send funds in the amount of the invoice total via wire transfer, ACH transfer, or other legacy funds transfer mechanism.

The invoice may include an expiration date/time, after which the invoice is no longer valid.

With some funds transfer methods, a number of hours or days may pass before the funds arrive in the designated temporary or rotational account.

Embodiments disclosed herein provide advantages for companies including automated reconciliation of legacy payments, real-time or near-real-time notification of specific invoice payment via legacy payments, and detailed accounting of such additional charges as transfer fees and foreign exchange fees.

### Dynamic Account System

A dynamic account provisioning system may be employed in certain embodiments to facilitate an improved payment processing system. Conventionally, payment systems suffer from the use of multiple account and invoice numbers to bill and pay for a product or service. For example, an order number may be used to purchase a product, then when it is delivered an invoice using a different numbering system is generated. Then payment is effectuated using payments to a bank account from the buyer's account via a mechanism, such as ACH funds transfer, whereby there is no ability to directly link the payment to the invoice generated by the seller. Conversely, in a dynamic account provisioning system, a bank account number may be generated for each invoice, and payment may be linked to the invoice through the dynamic account number. The linking may be accomplished by using the same number for the bank account number as the invoice, by deriving a new bank account number from the invoice number or creating hybrid numbering that translated an invoice number into a reversable identifier or globally unique identifier (GUID).

Conventionally, every bank-related financial transaction requires two key pieces of information to identify customers: the routing number and the account number. Together they make up the unique identifier by which to send an ACH or wire transfer. Account numbers are specific to each account holder. Similarly, routing numbers identify each banking institution with a unique numerical ID. Routing and account numbers are assigned to indicate exactly where funds in a transaction are coming from and going to. In some embodiments dynamic routing and account numbers may be employed and then discarded when the transaction is complete.

In one embodiment, a user may generate an invoice with a predetermined number. A dynamic system then creates a temporary, pseudo account number within a routing number which is logically tied to the invoice number. The logic may be mathematically derived and may “hash” in letters as well as numbers. The pseudo account number may then be used to process payment using conventional processing channels and clearing houses, such as ACH and wire transfer. Similarly a pseudo routing number may be employed, directing all transactions to a master pseudo institution. A user or system will see that an invoice has been paid because it will appear to the user as if the payment was made into a special account for just that invoice. By using the exact same number for the account and the invoice, redundant processing is avoided, there is no need to query a data structure to verify an invoice is paid, and the risk of human error is greatly reduced.

Once payment is made, the pseudo-account number may be re-used for a different transaction from different parties at a different time. To prevent multiple uses of a pseudo-account number that pseudo-account number may be “quarantined” for a predetermined time period. The pseudo-accounts are then provisional in operation. Some embodiments may employ mathematical “hashing” or date stamping to maintain compatibility with conventional clearing house numbering schemes, yet still keep a unique reusable number.

In some embodiments the pseudo-account number may be unique to a business entity and not just to a specific invoice. For example, and without limitation, the pseudo-account will be unique to a business and reusable by that business for every invoice. This may facilitate transactions for large volume users and minimize the need for a large quantity of pseudo-account numbers.

In operation a transfer routing entity is formed to function as a general ledger. Once a payment is received the pseudo-ACH account is credited. The transfer routing entity then transfers the money to the appropriate payee and the pseudo-ACH account is debited to show a zero balance. In some embodiments a user may have several accounts organized as virtual “wallets” wherein the methods described herein may be effectuated by starting and ending the process from a first wallet to a second user's wallet. This transfer to the appropriate payee (or payee's wallet) may be made in different currencies thus eliminating some steps in a cross-currency transaction. Wallets also may be effectuated for different currencies or processing. For example, and without limitation, the invoicing and billing may all use the same currency, but when the ultimate payee receives the money in their wallet in any currency they choose.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Operations

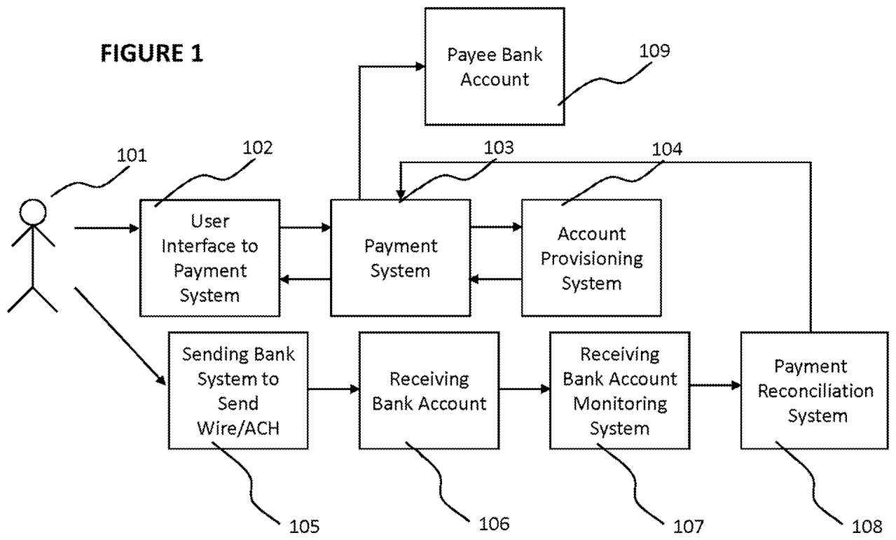

FIG. 1 describes an overview of a process which may be effectuated in certain embodiments. A user 101 may utilize a user interface 102 to interact with a payment system 103 to receive an invoice for goods or services. The payment system 103 may interact with an account provisioning system 104 to receive a destination bank account number and payment instructions specific to the invoice created. The payment system 103 may deliver the interface to the user 101 via the user interface 103. In certain embodiments, the payment system 101 may deliver the invoice to another system. When the user 101 receives the invoice with payment instructions, the user may utilize an existing bank mechanism 105 for creating a wire transfer, automated clearing house (ACH) transfer, or other legacy money transfer mechanism. The receiving bank identified by the account provisioning system 104 receives funds from the sending bank. A bank account monitoring system 107 may detect that funds have arrived and may deliver the account information and amount of funds to a payment reconciliation system 108. The payment reconciliation system 108 may notify the payment system 103 that a payment matching the amount required for a specific invoice has been received. The payment system 103 may mark the invoice as paid, may journal the transaction, and may close the invoice. The payment system may also send instructions to move money to a payee bank account 109.

Multiple Payors

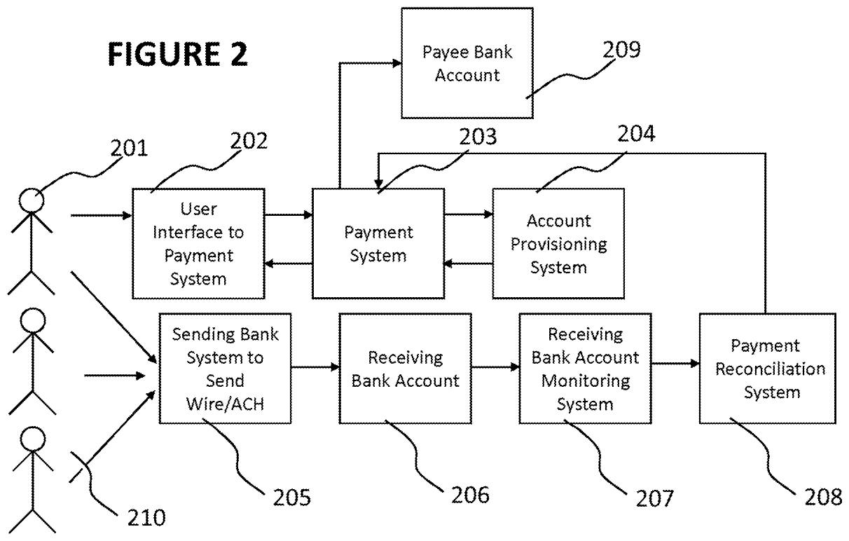

FIG. 2 illustrates a process for multiple payees to proffer payment. A user 201 may utilize a user interface 202 to interact with a payment system 203 to receive an invoice for goods or services. The payment system 203 may interact with an account provisioning system 204 to receive a destination bank account number and payment instructions specific to the invoice created. The payment system 203 may deliver the interface to the user 201 via the user interface 203. In certain embodiments, the payment system 201 may deliver the invoice to another system. When the user 201 receives the invoice with payment instructions, the user may utilize an existing bank mechanism 205 for creating a wire transfer, ACH transfer, or other legacy money transfer mechanism for funds in an amount equal to or less than the invoice amount. Additional payees 210 may also use an existing bank mechanism 205 to send funds to the account identified on the invoice. The receiving bank identified by the account provisioning system 204 receives funds from the sending banks. A bank account monitoring system 207 may detect that funds have arrived and may deliver the account information and amount of funds to a payment reconciliation system 208. The payment reconciliation system 208 may detect when total funds received by an account identified on an invoice equal or exceed the invoice amount then notify the payment system 203 that a payment matching the amount required for a specific invoice has been received. The payment system 203 may mark the invoice as paid, may journal the transaction, and may close the invoice. The payment system may also send instructions to move money to a payee bank account 209.

### Multiple Payees

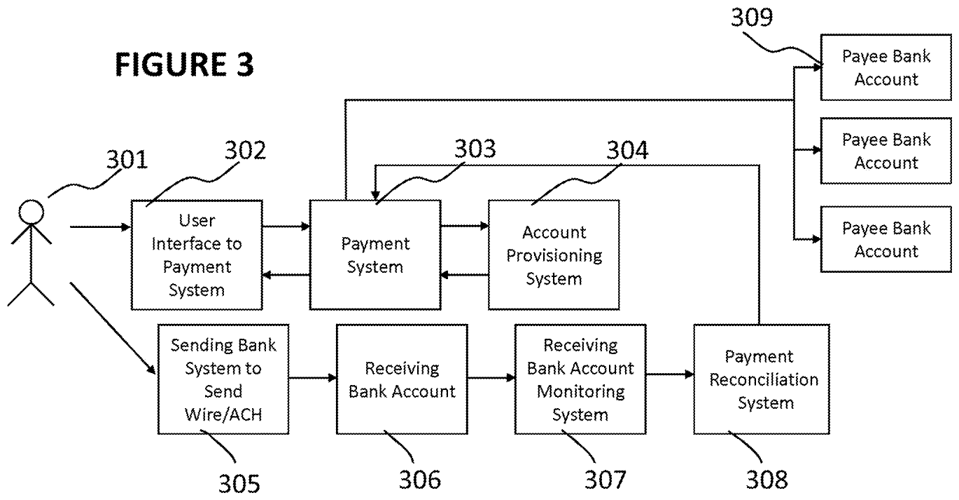

FIG. 3 illustrates a process for multiple payees to receive payment. A user 301 may utilize a user interface 302 to interact with a payment system 303 to receive an invoice for goods or services. The payment system 303 may interact with an account provisioning system 304 to receive a destination bank account number and payment instructions specific to the invoice created. The payment system 303 may record multiple payee accounts and portion of invoice for each that may receive funds. The payment system 303 may deliver the interface to the user 301 via the user interface 303. In certain embodiments, the payment system 301 may deliver the invoice to another system. When the user 301 receives the invoice with payment instructions, the user may utilize an existing bank mechanism 305 for creating a wire transfer, ACH transfer, or other legacy money transfer mechanism. The receiving bank identified by the account provisioning system 304 receives funds from the sending bank. A bank account monitoring system 307 may detect that funds have arrived and may deliver the account information and amount of funds to a payment reconciliation system 308. The payment reconciliation system 308 may notify the payment system 303 that a payment matching the amount required for a specific invoice has been received. The payment system 303 may mark the invoice as paid, may journal the transaction, and may close the invoice. The payment system 303 may also send instructions to move money to a payee bank accounts 309 in the amounts originally designated by the payment system. In certain embodiments, multiple payees and multiple payors may exist in the same process.

In the embodiments described herein, dynamic numbering techniques as described herein may be employed. A transfer routing entity or the functionality of a transfer routing entity may be accomplished using the account provisioning system described in the figures. In some embodiments, the functionality may be divided between other, including remote, sub-systems.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

We claim:

1. A transaction management method including:
receiving, from a payee, invoice information, said invoice information including a unique identifier;
creating a provisional account in response to said receiving, said provisional account including an identifier derived using the invoice information, said identifier operable as a portion of an automated clearing house (ACH) transaction;
communicating the provisional account identifier and invoice information to a payer;
receiving, over a network, transaction information;
comparing the transaction information to the provisional account identifier and;
transmitting to the payee transaction information in response to said comparing.

2. The method of claim 1 wherein the provisional account derived using the invoice information includes translating the invoice information to a numeric value.

3. The method of claim 1 further including:
deleting the provisional account.

4. The method of claim 1 wherein said transmitting the payee transaction information includes converting payment information to a different currency.

5. An improvement to a transaction method including:
receiving, from a payee, invoice information, said invoice information including a unique identifier;
creating a pseudo account in response to said receiving, said pseudo account including an identifier derived from the invoice information;
communicating the pseudo account identifier, a routing identifier, and invoice information to a payer;
receiving, over a network, transaction information, said transaction information including the routing information, the pseudo account identifier, and a payment amount;
applying the payment amount to the invoice and;
deleting the pseudo account.

6. The improvement of claim 5 further including:
converting the payment amount to a different currency.

7. The improvement of claim 5 further including:
transferring a port of the payment amount to a second payee.

8. The improvement of claim 5 further including:
notifying a reconciliation system that the payment amount is received;
matching amount of payment amount with the pseudo account number indicating that funds have arrived for the invoice, and
marking the invoice as paid in a reconciliation system.

9. An improvement to a payment system including:
receiving from a user an invoice with an invoice number;
dynamically creating a temporary, pseudo account number with an ACH compliant routing number which is logically tied to the invoice number;
processing a payment through a clearinghouse, said processing including transferring funds, and
deleting the pseudo account information.

10. The improvement of claim 9 wherein the logically tied includes either a mathematical derivation or a hash of letters and numbers.

11. The improvement of claim 9 wherein all payments are initially directed to a master pseudo institution.

12. The improvement of claim 9 wherein the deleting the pseudo account information is performed a predetermined time after the processing the payment.

13. The improvement of claim 9 further including:
converting the funds to a different currency than that in which the funds were received.
